(19) United States
(12) Patent Application Publication
(10) Pub. No.: US 2001/0034015 A1
(43) Pub. Date: Oct. 25, 2001

(54) Network based anonymous question and answer system

(76) Inventors: Arvind A. Raichur, Albuquerque, NM (US); Becky D. Raichur, Albuquerque, NM (US)

Correspondence Address: PEACOCK MYERS AND ADAMS P C, P O BOX 26927, ALBUQUERQUE, NM, 871256927

(21) Appl. No.: 09/782,323

(22) Filed: Feb. 12, 2001

Related U.S. Application Data
(60) Provisional application No. 60/181,920, filed on Feb. 11, 2000.

(51) Int. Cl. G09B 7/00

(52) U.S. Cl. 434/322

(57) ABSTRACT

A computer network based question and answer method and apparatus comprising providing a question from a human user and human user contact information to a computer control system, via the control system removing information from the question identifying the human user but retaining the human user contact information cross-indexed with the question, delivering the question with information removed to a human expert, receiving from the human expert via the control system an answer to the question, and sending the answer to the human user via the human user contact information.

### CROSS-REFERENCE TO RELATED APPLICATIONS

This application claims the benefit of the filing of U.S. Provisional Patent Application Ser. No. 60/181,920, entitled “Method of Internet Based Communication Based on Recognition & Exploitation of Natural Relationships Between Internet Based Constituencies”, filed on Feb. 11, 2000, and the specification thereof is incorporated herein by reference.

### BACKGROUND OF THE INVENTION

1. Field of the Invention (Technical Field)

The present invention relates to network-based communication and learning methods and apparatuses, particularly those involving a question-and-answer format.

2. Background Art

There are many web-based information and answer oriented sites on the Internet. However, most sites that deliver this service attempt to provide answers to questions for a wide range of questions. The methods of answering these questions vary widely, but usually involve either existing databases of information, which must be searched and then read, or being connected with an “expert” who then communicates with the person asking the question directly. Many times when the individual or consumer is connected to an expert neither party is satisfied with the transaction.

The problems with these existing methods are manifold. One of the most critical limitations of these existing methods is that the identity of the person asking the question is not kept confidential. This trend is continuing despite the fact that Internet users are demanding increased levels of privacy when obtaining information online and in conducting online transactions. In addition, society has increasingly focused on privacy issues and come to place a premium on the value of privacy. For example, many computer purchasers refused to buy Intel Corporation's Pentium III microprocessor when it was revealed that the chip contained components which made it possible to identify the user of the computer and track his or her online movements or purchases.

On the other hand, existing methods are inherently inefficient for the experts offering free advice. The experts often become overwhelmed with a large number of unanswerable questions. Many times the experts will simply receive comments from consumers rather than questions or the questions are not in the field of the expert or are unintelligible. In these cases the expert has wasted his or her time reading inappropriate and sometimes time-consuming questions. Yet another way that experts waste time in the current online paradigm is re-answering the same questions repeatedly. The present invention solves these problems.

Another serious limitation of the current online answer paradigm is that the scope of the material attempting to be covered is so broad that the quality of the responses may not always be covered as accurately and as thoroughly as desired. Moreover, in certain areas of expertise (e.g., the legal profession) licensing issues must be considered. For example, a person charged with a crime in Louisiana, should not be receiving advice from an attorney who is not licensed in Louisiana. In order to compensate for these limitations, the number of “experts” available for responding to questions is often increased. In the last example, this means having a Criminal Law Expert in every state. However, this usually requires increased costs, training and independent verification of the expert's level of expertise. All of this results in greater expense; increased levels of inefficiency and in many cases still may not be practically accomplished.

### SUMMARY OF THE INVENTION (DISCLOSURE OF THE INVENTION)

The present invention is of a computer network based question and answer method and apparatus comprising: providing a question from a human user and human user contact information to a computer control system; via the control system removing information from the question identifying the human user but retaining the human user contact information cross-indexed with the question; delivering the question with information removed to a human expert; receiving from the human expert via the control system an answer to the question; and sending the answer to the human user via the human user contact information. In the preferred embodiment, the question is rejected, the human user is so notified, and processing ceases if the question does not contain an interrogatory, is unintelligible, or is outside a predetermined subject area scope, all occurring before delivery of the question to an expert. Before delivery of the question, it is preferably categorized by subject area and/or geographical jurisdiction and a human user in that subject area chosen. Also before delivery, the invention searches an archive of previous questions and answers and, if the question and a corresponding answer have been previously provided to the control system, the corresponding answer is sent to the human user and further processing of the question ceases. The human expert is prompted to provide an answer after a predetermined time period after delivery of the question, and the question is delivered to a different human expert after a predetermined time period. The answer is checked for propriety and, if the answer does not contain an appropriate response, the question is delivered to a different human expert. The question and answer are rated for inclusion in an archive. The question and answer may be archived in a computer-accessible archive, either automatically or based on the rating assigned. The archive is preferably directly available to human users.

A primary object of the present invention is to provide an anonymous expert-based question-and-answer system that does not overwhelm human experts.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 is a block diagram of the preferred method and apparatus of the invention; and

FIG. 2 is a flow chart of the preferred method of the invention.

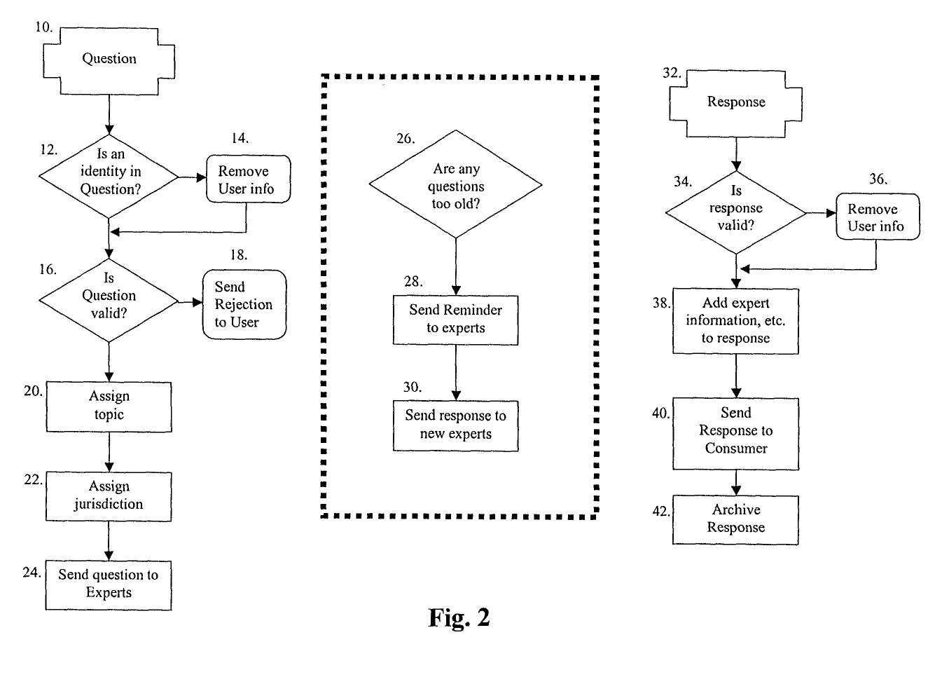

### DESCRIPTION OF THE PREFERRED EMBODIMENTS (BEST MODES FOR CARRYING OUT THE INVENTION)

The present invention is of a method of and apparatus for recognizing and then exploiting, for mutual benefit, the existing or naturally occurring relationships that exist between network-based constituencies. The present invention is capable of connecting experts and consumers with each other in a way that is mutually beneficial while avoiding the disadvantages of the prior art listed above.

The present invention is able to achieve this result by first identifying possible synergistic relationships between network-based constituencies as described below. By bringing these constituencies together each party is able to gain value.

For example, Internet-based online directories/indexes of experts currently exist (hereinafter a “Directory”). These Directories are generally available to anyone via the worldwide web and allow visitors a means of searching for the particular types of experts listed on that Directory. The success of these Directories ultimately depends upon their perceived value by the experts listed within it. Most experts judge the value of a Directory based on the number of referrals or inquiries generated from their listing on the Directory. As a result, most Directories want to increase the number of referrals provided to the experts listed on the Directory.

Internet based consumer-focused online portals and information sites dedicated to particular fields of knowledge also currently exist (hereinafter a “Portal”). The term “Portal” as used in the present invention refers to an Internet-based web site. However, an Intranet based information site also falls under the scope of the present invention.

Portals are typically also accessed via the World Wide Web and allow visitors an effective means of accessing large amounts of information related to areas of expertise. Users of these Portals are demanding greater services and access to increasing sources of sophisticated information. As a result, Portals are constantly attempting to anticipate and provide their users with new services the users will want and hopefully come to rely upon.

The present invention takes advantage of the unique opportunity available by identifying and then creating a synergistic relationship between a Portal and a Directory. As explained above, users of Portals are demanding more information and greater services while experts listed in Directories are demanding greater productivity from their Directories. The present invention allows for each parties' expectations to be met by assisting Portal users in obtaining expert information while simultaneously generating potential clients for experts in the Directory. At the same time, the present invention allows for the consumers to remain anonymous.

The experts are preferably anonymous to the consumers until they answer the consumer's question. In this way, the present invention can regulate the number of questions that any expert receives so that they are not overwhelmed. Furthermore, the present invention includes a filtering process to make sure that the experts are not riddled with repeated questions, unanswerable questions or questions outside of their expertise.

At the same time the experts' answers are also preferably filtered to make sure that the expert has (1) answered the question and (2) has not simply responded with “call me and we can talk about it.” This kind of response in contradictory to the present invention's intent that the consumer can be allowed anonymity.

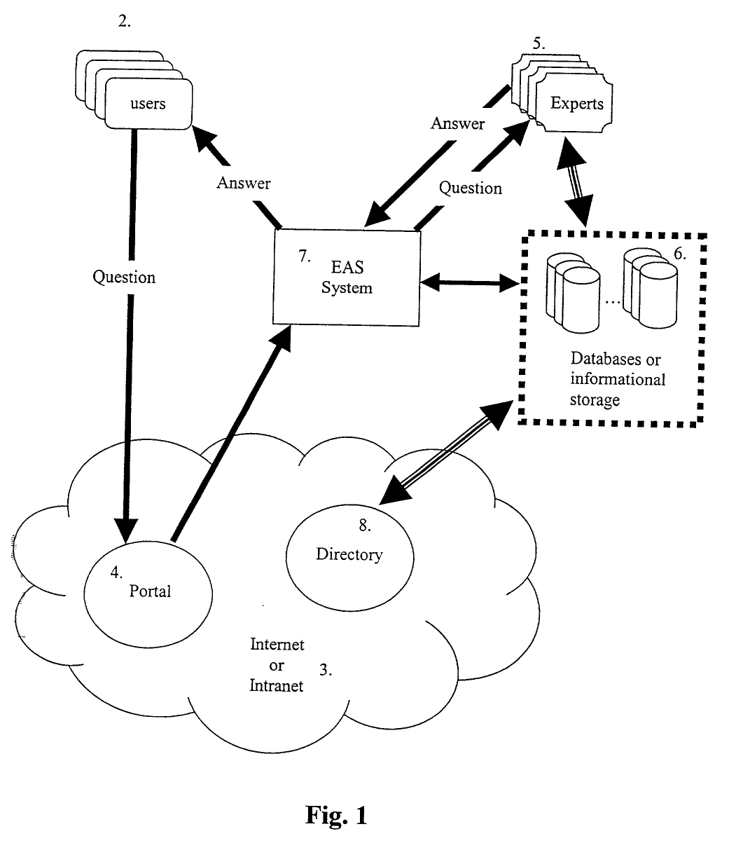

FIG. 1 is a simplified block diagram of the network-based communication and learning method and apparatus 1 of the invention, which recognizes and exploits the natural relationships that exist between network-based constituencies. The method and apparatus preferably employs servers and database management systems 6, and an expert system or collection of persons 5 to analyze data. The invention as implemented in the legal field takes advantage of existing databases of thousands of lawyers and matching it with the growing pool of consumers who need legal services.

Visitors 2 to a Portal 4 on the Internet or Intranet 3 (which also may contain Directories 8) can initiate a question on any topic which is provide to a coordinating system 7 (or the topic may be limited, such as to legal issues or any other area of specialized knowledge). These visitors are not required to include their identifying information, but in the present invention they are not precluded from identifying themselves if they wish. Each person initiating a question would be promised a reply within a reasonable period of time (such as two business days) (a “Question”).

The Question, along with all identifying information necessary to generate a response (the email address to mail the response to—but not the person's name or personal information), will be forwarded to a filter (“Filter”). The Filter could be a person, group of persons, computer(s), expert system or a collection of all or any of these.

After receiving the Question 10, the Filter performs the following actions:

1) Removes all identifying information of the sender from the question 14, if present 12.

In the present invention, if the consumer chooses to include personally identifying information in the question, their identity is still masked from the expert. It certainly falls within the scope of the present invention to turn this feature off and allow people to reveal their identities if they wish. The key is that the person initiating the question is never forced to reveal their identity or any other personal information, except an email address to which to send the responses. (It is important to note that in today's internet environment there are several sources on the internet that allow a consumer the ability to set up an anonymous e-mail account which could be used when asking a question that utilizes the present invention).

2) Reject any unanswerable questions 18, if present 16.

The Filter preferably rejects any questions which are (for example, without limitation):

a. Non-questions. Many times people just send comments, instead of asking a question (e.g., “I think OJ is guilty”). Another example is that sometimes the questions will arrive incomplete (e.g., “I need help” without any other information).

b. Unintelligible questions.

c. Unanswerable questions (e.g., “I was in a car wreck, how much money will I get”).

d. Questions that are out of scope of the expert area. (e.g., “What kind of questions can be asked during a trial?”) In the present invention this would include non-legal questions sent to legal experts.

When a consumer question is rejected they are preferably sent an email explaining that their question was rejected and they are given a reason for the rejection. The consumer can then re-ask the question.

3) Categorizes the Question by topic 20 (e.g., in the legal field the categories are preferably by practice areas such as criminal, bankruptcy, etc.).

Because many experts specialize any only a small part of their field, the present invention allows for the question to be categorized by topic. However, it certainly falls within the present invention for the allowance of only one topic.

4) Determines the relevant jurisdiction or geographic location of the source of the Question 22.

If possible or necessary in generating an answer, the expert must service the jurisdiction/geographic area in question (e.g., New Mexico, New York). Licensing issues may preclude experts from answering questions outside of their jurisdiction. Also, consumers may find value in identifying experts close to their location even if licensing is not an issue.

5) Searches the archive for the Question and, if found, resends a previous question and answer.

If the question has been asked in the jurisdiction and under the same topic before, then the sender could be sent the archived question and answer to see if this resolves the question in a more timely and efficient manner.

If the Filter does not reject the question and does not find an appropriate response in the response archive, and after the Filter has assigned a topic and jurisdiction/geographic area to the question, the present invention:

1) Searches the Directory database for experts to respond to the Question (the “Query”).

2) Sorts the results of the Query and selects experts to respond to Questions based on criteria earlier established (“Answering Expert”). In the legal example, such criteria might include but would not necessarily be limited to, the lawyers willingness to participate in the present invention, a determination of the lawyer's area of expertise and licensing and/or the fees paid by the attorney.

3) Forwards the Question to the Answering Experts 24 via e-mail or other means, but which in all cases preserves the customer's confidentiality.

The Question is sent directly to the expert's email address.

4) Calendars an appropriate response time, schedules reminders for the Answering Experts and tracks status.

To make sure that consumers derive the appropriate benefit from the present invention, the present invention preferably employs a check to make sure that the consumer's questions are answered in a timely fashion. If any question goes unanswered too long 26, a reminder is sent to the experts 28 and the question is sent to new experts 30.

5) Monitors the status of outstanding Questions and attempts to expedite responses. If no response is received within scheduled time frame generates a new Query and new set of Answering Experts.

6) Receives answers from the Answering Experts (“Answers”) 32 and matches Answers with the corresponding Questions.

Once the original Question and the Answer are matched, the Answer can then be put through a second filtering process. This process includes:

1) Checking to make sure that the response is appropriate 34.

If the response in non-responsive or inappropriate it is rejected and not sent to the consumer. An example of this occurs in the present invention when a consumer asks a question and the expert simply answers, “call me” (or something to the same effect). This type of response is rejected because this contradicts the goal of letting the user ask a question anonymously.

2) Rate the response for inclusion in the archive.

Although Answers may be appropriate, it may be that the Question is too narrow or too specific to be included in the archive of information. In the present invention the second filtering process makes the determination whether to include the Question and Answer in the archive.

If the Answer is not rejected (sent back to the Answering Expert for resubmission) then the present invention:

1) Formats the Answer to Question by inserting predefined text including a basic introduction, disclaimer and by inserting responses received from Answering Experts, but removing User information 36. The Answering Experts' contact information, or a hyperlink to the experts listing in the directory is also included 38. The Answer as reformatted is then sent to the User 40.

2) Creates an index and then adds new Questions and Answers into a searchable archive of past Questions and their corresponding Answers 42 thereby creating an ongoing, instant and self-help database. If the second In addition, the archive allows experts to review their responses and those of their colleagues, thereby creating new resources for the expert community.

The consumers who utilize the present invention are most usefully people who: (i) have real questions regarding the expert's area of expertise and, (ii) have little or no experience in dealing with the type of expert they contact. Furthermore, with the present invention's unique feature of allowing anonymity, the public at large is much more likely to seek expert advice than they would otherwise. Therefore, the present invention brings great value in being able to get initial expert advice in a confidential and cost-free (if desired) environment.

In addition, many types of experts find it difficult to market their services to the consumers who are in need of their expertise. As a result, the present invention allows Directory-listed experts the opportunity to evaluate large numbers of potential problems in their area of expertise and to “market” their services to potential clients. The consumers are anonymous, but the experts can put forth their name and contact information so that they can receive clients from the present invention.

The present invention can also act as a catalyst for the growth of expert communities. These communities allow for the collection of expert related information on related network sites and resources.

The invention may be employed on a private-company intranet. For example, a large company with an extensive Human Resources (“HR”) department often receives many, many HR questions each month. The present invention may be employed by such a corporation so that the company HR experts receive the benefit of the filter process so that inappropriate questions are rejected; recurring questions are not sent repeatedly and valid questions can be disbursed correctly across the HR staff. The employees in this situation would benefit from being able to ask questions anonymously. Furthermore, the present invention would allow an HR department to archive old questions for either employees to browse or to use as a tool in training new HR personnel.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A computer network based question and answer method comprising the steps of:
providing a question from a human user and human user contact information to a computer control system;
via the control system removing information from the question identifying the human user but retaining the human user contact information cross-indexed with the question;
delivering the question with information removed to a human expert;
receiving from the human expert via the control system an answer to the question; and
sending the answer to the human user via the human user contact information.

2. The method of claim 1 additionally comprising the steps of rejecting the question, so notifying the human user, and ceasing further processing of the question if the question does not contain an interrogatory, the rejecting, notifying, and ceasing steps occurring before the delivering step.

3. The method of claim 1 additionally comprising the steps of rejecting the question, so notifying the human user, and ceasing further processing of the question if the question is not intelligible, the rejecting step occurring before the delivering step.

4. The method of claim 1 additionally comprising the steps of rejecting the question, so notifying the human user, and ceasing further processing of the question if the question is outside a subject area scope, the rejecting step occurring before the delivering step.

5. The method of claim 1 additionally comprising the step of categorizing the question by subject area and choosing a human expert in that subject area, the categorizing step occurring before the delivering step.

6. The method of claim 1 additionally comprising the step of categorizing the question by geographical jurisdiction and choosing a human expert associated with that jurisdiction, the categorizing step occurring before the delivering step.

7. The method of claim 1 additionally comprising the steps of searching an archive of previous questions and answers and, if the question and a corresponding answer have been previously provided to the control system, sending the corresponding answer to the human user and ceasing further processing of the question, the searching, sending the corresponding answer, and ceasing steps occurring before the delivering step.

8. The method of claim 1 additionally comprising the step of prompting the human expert to provide an answer after a predetermined time period after the delivering step and before the receiving step.

9. The method of claim 1 additionally comprising the step of delivering the question to a different human expert after a predetermined time period after the delivering step and before the receiving step.

10. The method of claim 1 additionally comprising the steps of checking that the answer contains an appropriate response to the question prior to sending the answer to the human user and, if the answer does not contain an appropriate response, delivering the question to a different human expert.

11. The method of claim 10 additionally comprising the step of rating the question and the answer for inclusion in an archive.

12. The method of claim 1 additionally comprising the step of archiving the question and the answer in a computer-accessible archive.

13. The method of claim 12 additionally comprising the step of making directly available to human users the archive.

14. A computer network based question and answer apparatus comprising:
a computer control system receiving a question from a human user and human user contact information;
means for removing information from the question identifying the human user but retaining the human user contact information cross-indexed with the question;
means for delivering the question with information removed to a human expert;
means for receiving from the human expert an answer to the question;
means for sending the answer to the human user via the human user contact information.

15. The apparatus of claim 14 additionally comprising means for rejecting the question, so notifying the human user, and ceasing further processing of the question if the question does not contain an interrogatory.

16. The apparatus of claim 14 additionally comprising means for rejecting the question, so notifying the human user, and ceasing further processing of the question if the question is not intelligible.

17. The apparatus of claim 14 additionally comprising means for rejecting the question, so notifying the human user, and ceasing further processing of the question if the question is outside a subject area scope.

18. The apparatus of claim 14 additionally comprising means for categorizing the question by subject area and choosing a human expert in that subject area.

19. The apparatus of claim 14 additionally comprising means for categorizing the question by geographical jurisdiction and choosing a human expert associated with that jurisdiction.

20. The apparatus of claim 14 additionally comprising means for searching an archive of previous questions and answers and, if the question and a corresponding answer have been previously provided to the control system, sending the corresponding answer to the human user and ceasing further processing of the question, the searching, sending the corresponding answer.

21. The apparatus of claim 14 additionally comprising means for prompting the human expert to provide an answer after a predetermined time period.

22. The apparatus of claim 14 additionally comprising means for delivering the question to a different human expert after a predetermined time period.

23. The apparatus of claim 14 additionally comprising means for checking that the answer contains an appropriate response to the question prior to sending the answer to the human user and, if the answer does not contain an appropriate response, delivering the question to a different human expert.

24. The apparatus of claim 23 additionally comprising means for rating the question and the answer for inclusion in an archive.

25. The apparatus of claim 14 additionally comprising means for archiving the question and the answer in a computer-accessible archives 26. The apparatus of claim 25 additionally comprising means for making directly available to human users the archive.
